(19) United States
(12) Patent Application Publication
(10) Pub. No.: US 2005/0019035 A1
(43) Pub. Date: Jan. 27, 2005

(54) Data communications system, station device, subscriber device, redundant configuration switch determination method, operation control method, and program therefor

(76) Inventor: Tatsuya Egashira, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/889,252

(22) Filed: Jul. 13, 2004

(30) Foreign Application Priority Data
Jul. 23, 2003 (JP) 277947/2003

(51) Int. Cl. H04J 14/00

(52) U.S. Cl. 398/71

(57) ABSTRACT

A data communications system switches systems without using an OpS. An OLT determines one of ONTs forming a redundant configuration as a current ONT by performing ranging on the ONTs. When a fault occurs between the coupler and the current ONT, the OLT switches from the current ONT to the standby ONT by activating the standby ONT by performing the ranging on the ONTs again.

### BACKGROUND OF THE INVENTION

1. Field of the Invention

The present invention relates to a data communications system, a station device, a subscriber device, a redundant configuration switch determination method, an operation control method, and a program therefor, and more specifically to a data communications system in which a plurality of subscriber devices forming a redundant configuration are connected to a station device through an optical multi/demultiplexer. 2. Description of the Related Art

A recommendation prescribing the redundant configuration of a PON (Passive Optical Network) is stated in ITU-T Recommendation G.983.5 “A BROADBAND OPTICAL ACCESS SYSTEM WITH ENHANCED SURVIVABILITY”.

FIG. 11 shows the configuration of the conventional PON. As shown in FIG. 11, the conventional PON includes an OpS (Operation System) 100, an OLT (Optical Line Terminal) 200 which is a station device, a coupler 300, ONTs (Optical Network Terminals)/ONUs (Optical Network Units) 400 to 600 which are subscriber devices. The ONT 400 includes PON LTs 401 and 402, and the circuit between the ONT 400 and the coupler 300 is duplexed.

In the ONT 400, assuming that the PON LT 401 is a current system (active system), and the PON LT 402 is a standby system. When there occurs a fault between the current PON LT 401 and the coupler 300, a PON LT 202 of the OLT 200 detects the fault by the interruption of the communications with the current PON LT 401, and notifies the OpS 100 of the occurrence of the fault through a control H/W or S/W 201 of the OLT 200 (steps S1 and S2).

Upon receipt of the notification from the OLT 200, the OpS 100 transmits to the OLT 200 a switch instruction from the current PON LT 401 to the standby PON LT 402 (steps S3 and S4). Thus, the current PON LT 401 is switched to the standby PON LT 402.

Described below is the system disclosed in Japanese Patent Laid-Open No. 2001-203735 (page 3 to 6, FIGS. 1 to 3). In the system described in Japanese Patent Laid-Open No. 2001-203735, a plurality of NTs (Network Terminals) are connected to a current LT (Line Terminal) and a standby LT through a star coupler. The current LT performs ranging by polling to the plurality of NTs, and the standby LT receives a ranging frame from the plurality of NTs by the ranging, thereby monitoring the correctness of the circuit between the standby LT and the star coupler. When the circuit between the standby LT and the star coupler is in a normal state when a fault is detected between the current LT and the star coupler, the current LT is switched to the standby LT.

The ranging is described in ITU-T Recommendation G.983.1 “HIGH SPEED OPTICAL ACCESS SYSTEMS BASED ON PASSIVE OPTICAL NETWORK”.

In the PON shown in FIG. 11, when a fault is detected, the OLT 200 notifies the OpS 100 of the occurrence of the fault and the OpS 100 transmits an instruction to switch from the current PON LT 401 to the standby PON LT 402, thereby switching the systems. However, if the systems can be switched without using the OpS 100, the switching time can be shortened and the load of the OpS 100 can be reduced. Therefore, it is desired that an OLT can determine the switch from a current ONT to a standby ONT.

On the other hand, in the system described in Japanese Patent Laid-Open No. 2001-203735, it is assumed that the circuit between each NT and the star coupler is in the normal state, and the correctness of the circuit between the standby LT and the star coupler is monitored through ranging. Therefore, the OLT cannot determine the switch from the current ONT to the standby ONT and the execution of the switch.

### BRIEF SUMMARY OF THE INVENTION

The present invention aims at providing a data communications system, a station device, a subscriber device, a redundant configuration switch determination method, an operation control method, and a program enable a switch operation to be performed without using an OpS.

A data communications system according to the present invention is a system in which a plurality of subscriber devices forming a redundant configuration are connected to a station device through an optical multi/demultiplexer, and the station device includes control means determining from among the plurality of subscriber devices a subscriber device for communicating with the station device by performing ranging on the plurality of subscriber devices.

A redundant configuration switch determination method according to the present invention is a method for use with a data communications system in which a plurality of subscriber devices forming a redundant configuration are connected to a station device through an optical multi/demultiplexer, and the station device determines from among the plurality of subscriber devices a subscriber device for communicating with the station device by performing ranging on the plurality of subscriber devices.

A station device according to the present invention is a device in a data communications system in which a plurality of subscriber devices forming a redundant configuration are connected to a station device through an optical multi/demultiplexer, and includes control means determining from among the plurality of subscriber devices a subscriber device for communicating with the station device by performing ranging on the plurality of subscriber devices.

A redundant configuration switch determination method is a method for a station device in a data communications system in which a plurality of subscriber devices forming a redundant configuration are connected to a station device through an optical multi/demultiplexer, and determines from among the plurality of subscriber devices a subscriber device for communicating with the station device by performing ranging on the plurality of subscriber devices.

A subscriber device according to the present invention is a subscriber device in a data communications system which includes a station device, an optical multi/demultiplexer, and a plurality of subscriber devices forming a redundant configuration connected to the station device through the optical multi/demultiplexer, and in which the station device determines from among the plurality of subscriber devices a subscriber device for communicating with the station device by performing ranging on the plurality of subscriber devices, and includes transmission means transmitting to the station device a ranging response signal for use in determining a subscriber device for communicating with the station device upon receipt of a ranging request signal transmitted from the station device to the plurality of subscriber devices.

An operation control method according to the present invention is a method of a subscriber device in a data communications system which includes a station device, an optical multi/demultiplexer, and a plurality of subscriber devices forming a redundant configuration connected to the station device through the optical multi/demultiplexer, and in which the station device determines from among the plurality of subscriber devices a subscriber device for communicating with the station device by performing ranging on the plurality of subscriber devices, and includes a step of transmitting to the station device a ranging response signal for use in determining a subscriber device for communicating with the station device upon receipt of a ranging request signal transmitted from the station device to the plurality of subscriber devices.

A program according to the present invention is a program used to direct a computer to execute a redundant configuration switch determination method of a station device in a data communications system in which a plurality of subscriber devices forming a redundant configuration are connected to a station device through an optical multi/demultiplexer, and a step of determining from among the plurality of subscriber devices a subscriber device for communicating with the station device by performing ranging on the plurality of subscriber devices.

Another program according to the present invention is a program used to direct a computer to execute an operation control method of a subscriber device in a data communications system which includes a station device, an optical multi/demultiplexer, and a plurality of subscriber devices forming a redundant configuration connected to the station device through the optical multi/demultiplexer, and in which the station device determines from among the plurality of subscriber devices a subscriber device for communicating with the station device by performing ranging on the plurality of subscriber devices, and includes a step of transmitting to the station device a ranging response signal for use in determining a subscriber device for communicating with the station device upon receipt of a ranging request signal transmitted from the station device to the plurality of subscriber devices.

Thus, according to the present invention, a station device performs the ranging on a plurality of subscriber devices forming a redundant system, and determines a subscriber device for communicating with the station device, thereby switching a current subscriber device to a standby subscriber device without receiving a switch instruction from an OpS (Operation System).

According to the present invention, in a system of a PON (Passive Optical Network) in which a plurality of ONTs (Optical Network Terminals)/ONUs (Optical Network Units) forming a redundant system are connected to an OLT (Optical Line Terminal) through a coupler, a data communications system capable of performing a switching operation without the OpS connected to the OLT is realized.

The OLT activates one of ONTs forming a redundant configuration by performing a sequence called “ranging” when it is ONT-activation-controlled by the OpS. When a fault of a current ONT or power-down, or a fault of an optical fiber between a coupler and a current ONT occurs, the OLT detects it, and performs a ranging sequence again, thereby switching into a standby ONT.

Thus, using the ranging, the OLT can determine with which ONT it is to communicate, and therefore can realize the switching operation without a switch instruction from the OpS.

The effect of the present invention is that a switching operation can be performed without using an OpS. That is, the station device performs the ranging on a plurality of subscriber devices forming a redundant system, and determines a subscriber device for communicating with the station device. As a result, the station device can switch from a current subscriber device to a standby subscriber device without a switch instruction from an OpS (Operation System).

### BRIEF DESCRIPTION OF THE DRAWINGS

FIG. 1 shows the configuration of a data communications system according to an embodiment of the present invention;

FIG. 2 is an explanatory view of the operations of the data communications system according to the embodiment of the present invention;

FIG. 3 shows the outline of a sequence of the operations of the data communications system according to the embodiment of the present invention;

FIG. 4 shows a sequence of the operations of the data communications system until one of the ONTs forming a redundant configuration is activated as a current system according to the embodiment of the present invention;

FIG. 5 shows a sequence of the operations when the ranging fails in the ranging sequence shown in FIG. 4;

FIG. 6 shows a sequence of the switching operation of the data communications system according to the embodiment of the present invention when a fault occurs;

FIG. 7 shows the state transition of the OLT shown in FIG. 1;

FIG. 8 is a flowchart showing the operations of the OLT shown in FIG. 1;

FIG. 9 shows the state transition of the ONT shown in FIG. 1;

FIG. 10 is a flowchart showing the operations of the ONT shown in FIG. 1; and

FIG. 11 shows the configuration of a conventional PON.

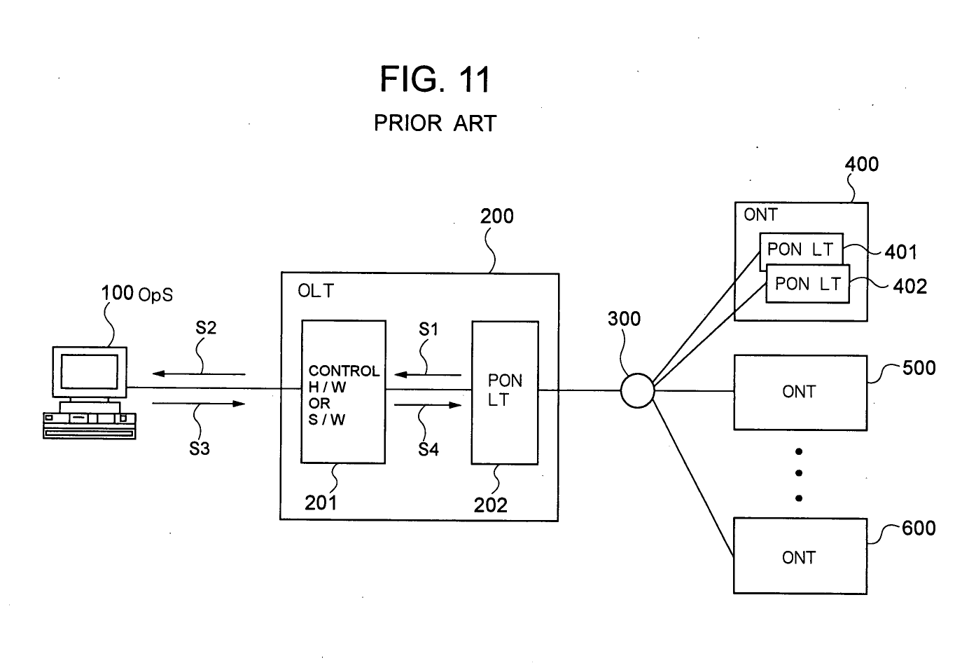

### DETAILED DESCRIPTION OF THE PREFERRED EMBODIMENTS

The embodiment of the present invention is described below by referring to the attached drawings.

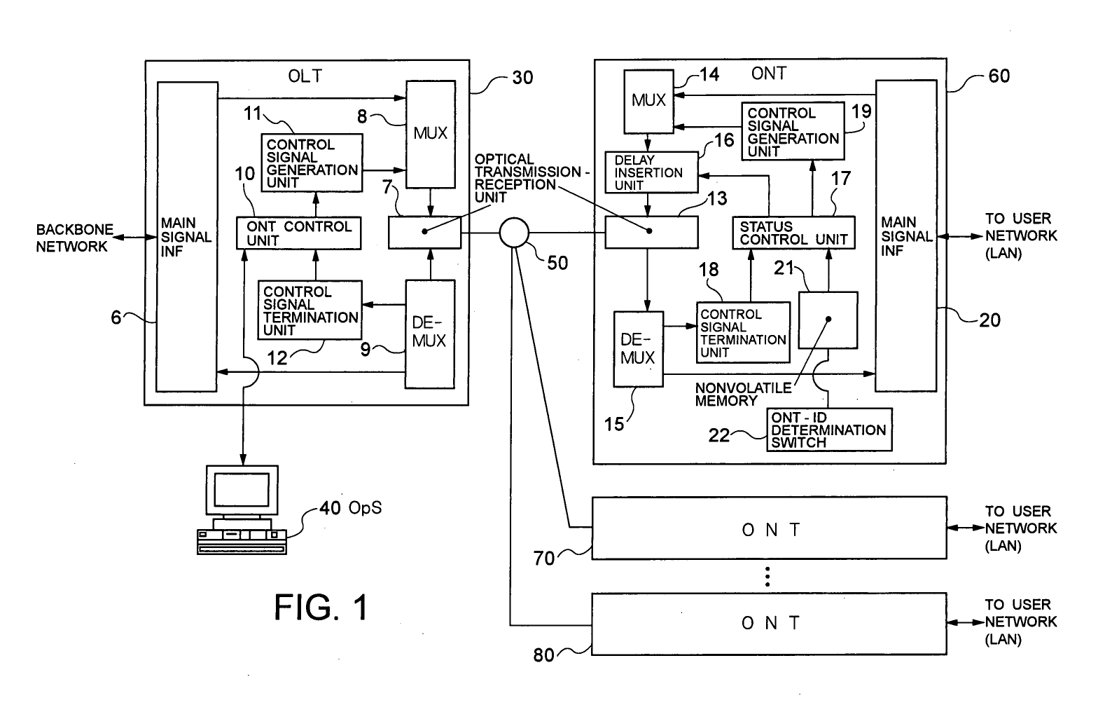

FIG. 1 shows the configuration of the data communications system in the PON (Passive Optical Network) according to the embodiment of the present invention.

As shown in FIG. 1, the data communications system according to the embodiment of the present invention is a PON system in which ONTs (Optical Network Terminals)/ONUs (Optical Network Units) 60 to 80 which are a plurality of terminal devices (subscriber devices) provided on the user side are connected to an OLT (Optical Line Terminal) 30 which is a device (station device) provided on the station side through a coupler 50 with optical fibers.

To the OLT 30, an OpS (Operation System) 40 which is a control terminal is connected through, for example, a LAN (Local Area Network).

The OpS 40 is a management system of a PON which issues an instruction of an ONT activation request to an ONT control unit 10 of the OLT 30, and receives a production number notification of an activated ONT, and a notification of an occurrence of a system switch and a fault.

The OLT 30 comprises a main signal INF 6, an optical transmission-reception unit 7, a MUX 8, a DE-MUX 9, an ONT control unit 10, a control signal generation unit 11, and a control signal termination unit 12.

The ONT control unit 10 not only communicates with the OpS 40, but also performs an appropriate process in response to a notification of the reception from the control signal termination unit 12 of a ranging response signal from the ONTs 60 to 80, and instructs the control signal generation unit 11 to generate and transmit all control signals to be transmitted to the ONTs 60 to 80 such as a ranging request signal, etc.

The main signal INF 6 transmits a down main signal received from the backbone network to the MUX 8, and a up main signal received from the DE-MUX 9 to the backbone network.

The MUX 8 adjusts the timing of the control signal from the control signal generation unit 11 to the ONTs 60 to 80 and the main signal from the main signal INF 6, and outputs them to the optical transmission-reception unit 7.

The control signal generation unit 11 generates the following control signals to be transmitted to the ONTs 60 to 80 at an instruction from the ONT control unit 10. The descriptions in the parentheses after the names of the following control signals indicate the corresponding parameters.
transmit request code assignment signal (destination ONT-ID, transmit request code)
ranging request signal (transmit request code)
delay adjustment request signal (destination ONT-ID)
activation determined signal (destination ONT-ID, production number)
ranging value assignment signal (destination ONT-ID, ranging value)

The DE-MUX 9 demultiplexes a signal output from the optical transmission-reception unit 7 to a control signal and a main signal, and outputs them to the control signal termination unit 12 and the main signal INF 6 respectively.

The control signal termination unit 12 notifies the ONT control unit 10 of the reception of the following control signal transmitted from the ONTs 60 to 80 and the parameter contained therein. The description in the parentheses after the name of the following control signal indicates the corresponding parameters.
ranging response signal (source ONT-ID, production number)

The ONT 60 comprises an optical transmission-reception unit 13, a MUX 14, a DE-MUX 15, a delay insertion unit 16, a status control unit 17, a control signal termination unit 18, a control signal generation unit 19, a main signal INF 20, a nonvolatile memory 21, and an ONT-ID determination switch 22. The configurations of the ONTs 70 and 80 are the same as the configuration of the ONT 60.

The status control unit 17 performs an appropriate process in response to a notification of the reception from the control signal termination unit 18 of each control signal such as a ranging request signal, etc. from the OLT 30, and instructs the control signal generation unit 19 to generate and transmit the ranging response signal to the OLT 30.

The main signal INF 20 transmits an up main signal received from the user network to the MUX 14, and transmits the down main signal received from the DE-MUX 15 to the user network.

The MUX 14 adjusts the timing of the control signal to the OLT 30 output from the control signal generation unit 19 and the main signal output from the main signal INF 20, and outputs them to the optical transmission-reception unit 13 through the delay insertion unit 16.

The control signal generation unit 19 generates the following control signal to be transmitted to the OLT 30 at an instruction from the status control unit 17. The description in the parentheses after the name of the following control signal indicates the corresponding parameters.
ranging response signal (source ONT-ID, production number)

The delay insertion unit 16 generates a small delay at random at an instruction from the status control unit 17, and shifts the phase of the signal to be transmitted to the OLT 30. The delay is assumed to be fixedly maintained so far as the system is not powered down. When a ranging value assignment signal is received, the delay insertion unit 16 also fixedly inserts a ranging value (delay value) received from the status control unit 17.

The DE-MUX 15 demultiplexes the signal output from the optical transmission-reception unit 13 into a control signal and a main signal, and outputs them to the control signal termination unit 18 and the main signal INF 20 respectively.

The control signal termination unit 18 compares the destination ONT-ID contained in the following control signals received from the OLT 30 with the ONT-ID stored in the nonvolatile memory 21, and notifies the status control unit 17 of the reception of the control signal and the parameter therein. The descriptions in the parentheses after the names of the following control signals indicate the corresponding parameters.
transmit request code assignment signal (destination ONT-ID, transmit request code)
ranging request signal (transmit request code)
delay adjustment request signal (destination ONT-ID)
activation determined signal (destination ONT-ID, production number)
ranging value assignment signal (destination ONT-ID, ranging value)

The ONT-ID determination switch 22 writes any ONT-ID (ONT identification number) into the nonvolatile memory 21. The nonvolatile memory 21 also retains the production number of the ONT 60, which the status control unit 17 is notified of with the ONT-ID.

The optical transmission-reception unit 7 of the OLT 30 and the optical transmission-reception unit 13 of the ONT 60 are connected by an optical fiber through the coupler 50, and the ONTs 70 and 80 are similarly connected to the OLT 30.

The operations of the data communications system according to the embodiment of the present invention are described now below by referring to the attached drawings.

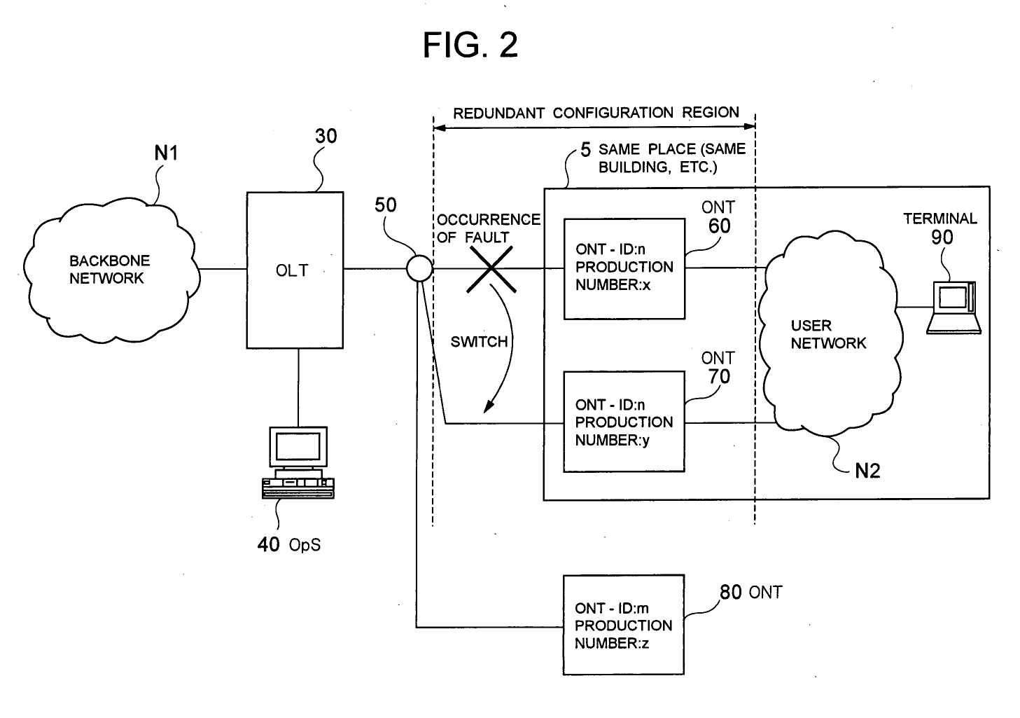

FIG. 2 is an explanatory view of the operations of the data communications system according to the embodiment of the present invention, and shows the same reference numerals for the same components shown in FIG. 1.

As shown in FIG. 2, the OLT 30 is connected to a backbone network N1, and a main signal is transmitted to and received from the backbone network N1. On the other hand, the ONTs 60 and 70 connected to the OLT 30 through the coupler 50 have the same ONT-IDs, are located in the same place 5 such as the same building, etc., and communicate a main signal with a user terminal 90 through a user network (LAN) N2. That is, the ONTs 60 and 70 having the same ONT-IDs configure a redundant system to the coupler 50.

The ONT 80 and the ONTs 60 and 70 have different ONT-IDs. The ONT 80 is not involved in the above-mentioned redundant system. The ONT-ID of the ONT 60 is “n”, the production number of the ONT 60 is “x”, the ONT-ID of the ONT 70 is “n”, the production number of the ONT 70 is “y”, the ONT-ID of the ONT 80 is “m”, and the production number of the ONT 80 is “z”.

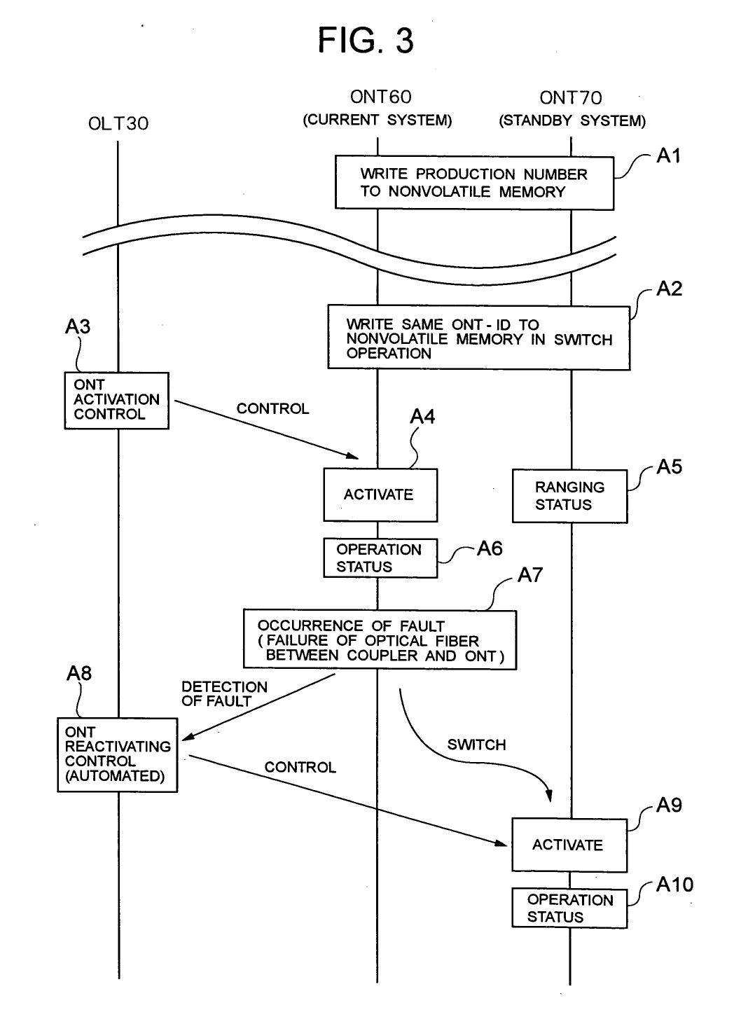

FIG. 3 shows the outline of the sequence of the operations of the data communications system according to the embodiment of the present invention. The outline of the operations of the data communications system according to the embodiment of the present invention is described below by referring to FIGS. 2 and 3.

Before configuring the system shown in FIG. 2, different production numbers “x”, “y”, and “z” are written respectively to the nonvolatile memory 21 of the ONTs 60 to 80 (step A1 shown in FIG. 3).

When the ONTs 60 and 70 are located in the same place 5, the owner in the corresponding place operates the ONT-ID determination switches 22 of the ONTs 60 and 70, and writes the same ONT-ID “n” to the nonvolatile memory 21 of the ONTs 60 and 70 (step A2 shown in FIG. 3). Furthermore, a different ONT-ID “m” is written to the nonvolatile memory 21 of the ONT 80.

Upon receipt of the notification of the OpS 40, the OLT 30 performs ONT activation control on the same ONT-ID “n” of the ONTs 60 and 70 forming a redundant system (step A3 shown in FIG. 3). By the ONT activation control, the ONT 60 is activated as a current system, and the ONT 70 enters a ranging status as a standby system (steps A4 and A5 shown in FIG. 3).

Activating an ONT means the ONT in an operation status. Therefore, the ONT 60 activated in step A4 enters the operation status (step A6 shown in FIG. 3). Thus, the terminal 90 can communicate with the ONT 60 through the user network N2, and can communicate a main signal with the OLT 30 and the subsequent backbone network N1.

As shown in FIG. 2, when a fault of an optical fiber occurs between the coupler 50 and the current ONT 60 (step A7 shown in FIG. 3), the OLT 30 detects the fault by the interrupt of the communications with the ONT 60, and the ONT activation control is automatically performed again (step A8 shown in FIG. 3).

By the ONT activation control in step A8, the standby ONT 70 in the ranging status is activated and enters the operation status (steps A9 and A10 shown in FIG. 3). Thus, the user terminal 90 can communicate with the ONT 70 through the user network N2, and can communicate a main signal with the OLT 30 and the subsequent backbone network N1.

The ONT 80 can be activated and operated without an effect on the sequence shown in FIG. 3.

The above-mentioned operations are explained in more detail by referring to the attached drawings.

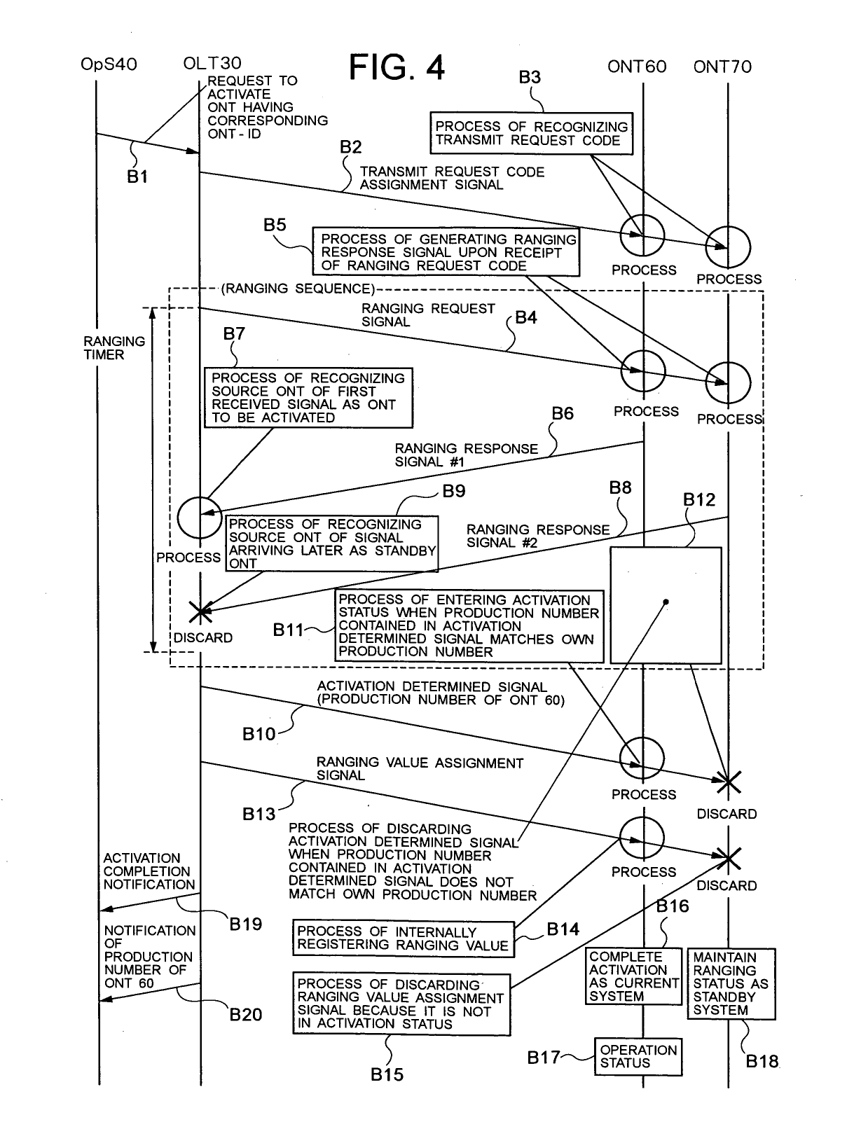

FIG. 4 shows a sequence of the operations of the data communications system according to the embodiment of the present invention until one of the ONTs 60 and 70 forming a redundant configuration is activated as a current system. First, the operations performed until one of the ONTs 60 and 70 forming a redundant configuration is activated as a current system are explained by referring to FIGS. 1, 2, and 4.

As described above, the ONTs 60 and 70 hold the same ONT-IDs and different production numbers in the nonvolatile memories 21.

By the operations of the operator, an ONT activation request is issued from the OpS 40 to the OLT 30 on the same ONT-IDs held by the ONTs 60 and 70 forming a redundant system (step B1 shown in FIG. 4).

In response to the ONT activation request from the OpS 40, the OLT 30 assigns a unique identification code for issuing a transmit request to the ONTs 60 and 70 (step B2 shown in FIG. 4). That is, the OLT 30 transmits a transmit request code assignment signal including an ONT-ID “n” as a destination ONT-ID and a transmit request code. Thus, each of the ONTs 60 and 70 recognizes the transmit request code assigned to the ONT (step B3 shown in FIG. 4).

Then, the OLT 30 performs a ranging sequence. First, the OLT 30 transmits to the ONTs 60 and 70 a ranging request signal including the transmit request code assigned to the ONTs 60 and 70 (step B4 shown in FIG. 4). The OLT 30 also starts the ranging timer not shown in the attached drawings, and monitors the presence/absence of a response from the ONTs 60 and 70.

When each of the ONTs 60 and 70 receives the ranging request signal including the transmit request code assigned to the ONT, each of them generates a ranging response signal including a source ONT-ID “n” and the production number of the ONT, and transmits it to the OLT 30 (steps B5, B6, and B8 shown in FIG. 4).

The OLT 30 recognizes the source ONT (the ONT 60 in the present embodiment) of the first received ranging response signal in the ranging response signals from the ONTs 60 and 70 to be activated (step B7 shown in FIG. 4), and the source ONT (the ONT 70 in the present embodiment) of the later received ranging response signal as a standby ONT (step B9 shown in FIG. 4).

The OLT 30 then transmits an activation determined signal including ONT-ID of a destination “n” and the production number of the ONT 60, so as to activate the ONT 60 as a current system (step B10 shown in FIG. 4).

Each of the ONTs 60 and 70 receives the activation determined signal from the OLT 30. At this time, the ONT 60 is activated because the production number contained in the received activation determined signal matches the production number of the ONT 60 (step B11 shown in FIG. 4). However, since the production number contained in the received activation determined signal does not match the production number of the ONT 70, the ONT 70 is not activated and the signal is discarded (step B12 in FIG. 4).

To appropriately delay the up signal of the ONT 60 to avoid the conflict between the up signal from the ONT 60 and the up signal from the ONT 80, the OLT 30 transmits a ranging value assignment signal including the delay value and the destination ONT-ID “n” (step B13 shown in FIG. 4).

Each of the ONTs 60 and 70 receives the ranging value assignment signal from the OLT 30, and the delay value contained on the ranging value assignment signal is set in the delay insertion unit 16 only for the ONT 60 to be activated (step B14 shown in FIG. 4), and the ONT 70 discards the ranging value assignment signal (step B15 shown in FIG. 4).

Thus, the ONT 60 is activated as a current ONT, and enters the operation status (steps B16 and B17 shown in FIG. 4). On the other hand, the ONT 70 holds the ranging status as a standby ONT (step B18 shown in FIG. 4).

The OLT 30 notifies the OpS 40 of the activation completion, and notifies it of the production number of the activated ONT 60 (steps B19 and B20 shown in FIG. 4).

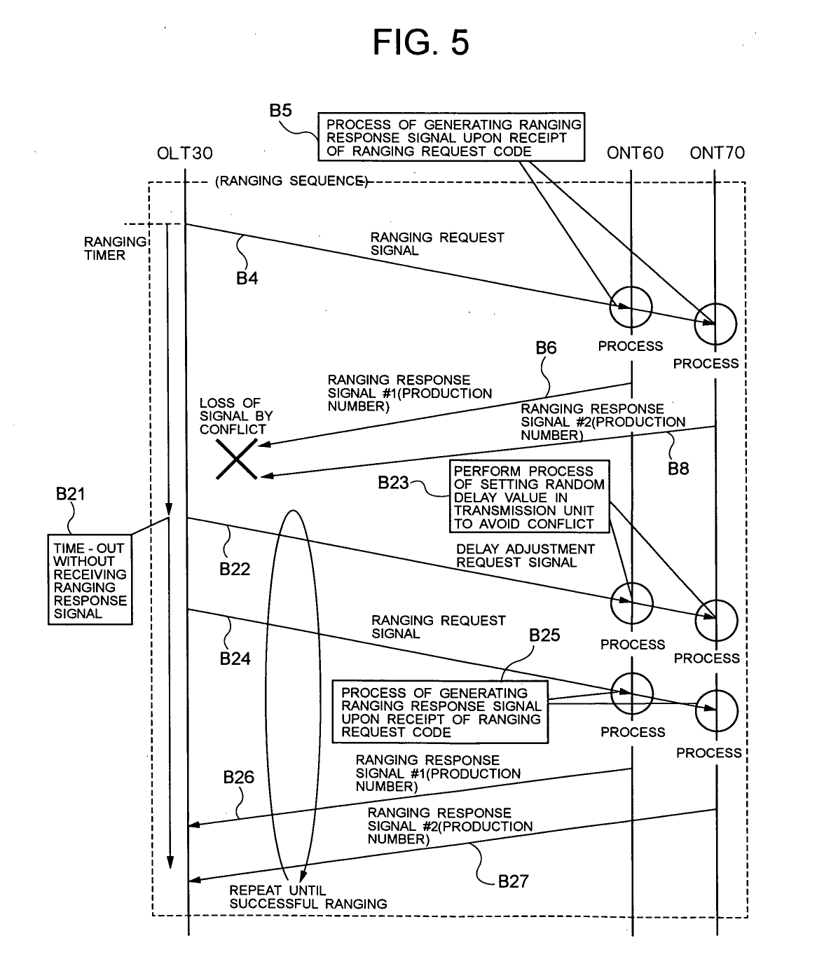

In the ranging sequence shown in FIG. 4, the operation performed when the ranging fails (when the OLT 30 cannot receive a ranging response signal within a predetermined time after transmitting a ranging request signal) is explained below by referring to FIG. 5. FIG. 5 shows a sequence of the operations performed when the ranging fails in the ranging sequence shown in FIG. 4. In FIG. 5, the steps B1 to B3 and B10 to B20 shown in FIG. 4 are omitted. In FIG. 5, the components also shown in FIG. 4 are assigned the same reference numerals.

In the ranging sequence, the OLT 30 first transmits to the ONTs 60 and 70 a ranging request signal including a transmit request code assigned to the ONTs 60 and 70 (step B4 shown in FIG. 5). The OLT 30 starts the ranging timer and monitors the presence/absence of a response from the ONTs 60 and 70.

When each of the ONTs 60 and 70 receives the ranging request signal including the transmit request code assigned to the ONT, each of them generates a ranging response signal including a source ONT-ID “n” and the production number of the ONT, and transmits it to the OLT 30 (steps B5, B6, and B8 shown in FIG. 5). However, the ranging response signals transmitted from the ONTs 60 and 70 are assumed to be lost after a conflict.

The OLT 30 recognizes the failure of the ranging when the ranging timer expires without receiving a ranging response signal, and transmits a delay adjustment request signal including a destination ONT-ID “n” to the ONTs 60 and 70 (steps B21 and B22 in FIG. 5).

When the delay adjustment request signal is received, each status control unit 17 of the ONTs 60 and 70 instructs the delay insertion unit 16 to fixedly and permanently insert a random delay in the uplink direction (step B23 shown in FIG. 5).

Then, the OLT 30 transmits again to the ONTs 60 and 70 a ranging request signal including the transmit request code assigned to the ONTs 60 and 70 (step B24 shown in FIG. 5), thereby starting the ranging timer.

Upon receipt of the ranging request signal including the transmit request code assigned to the ONT, each of the ONTs 60 and 70 generates a ranging response signal including a source ONT-ID “n” and the production number of the ONT, and transmits it to the OLT 30 again (steps B25, B26, and B27 shown in FIG. 5).

Until the ranging can be successfully performed, the processes in steps B22 to B27 are repeated.

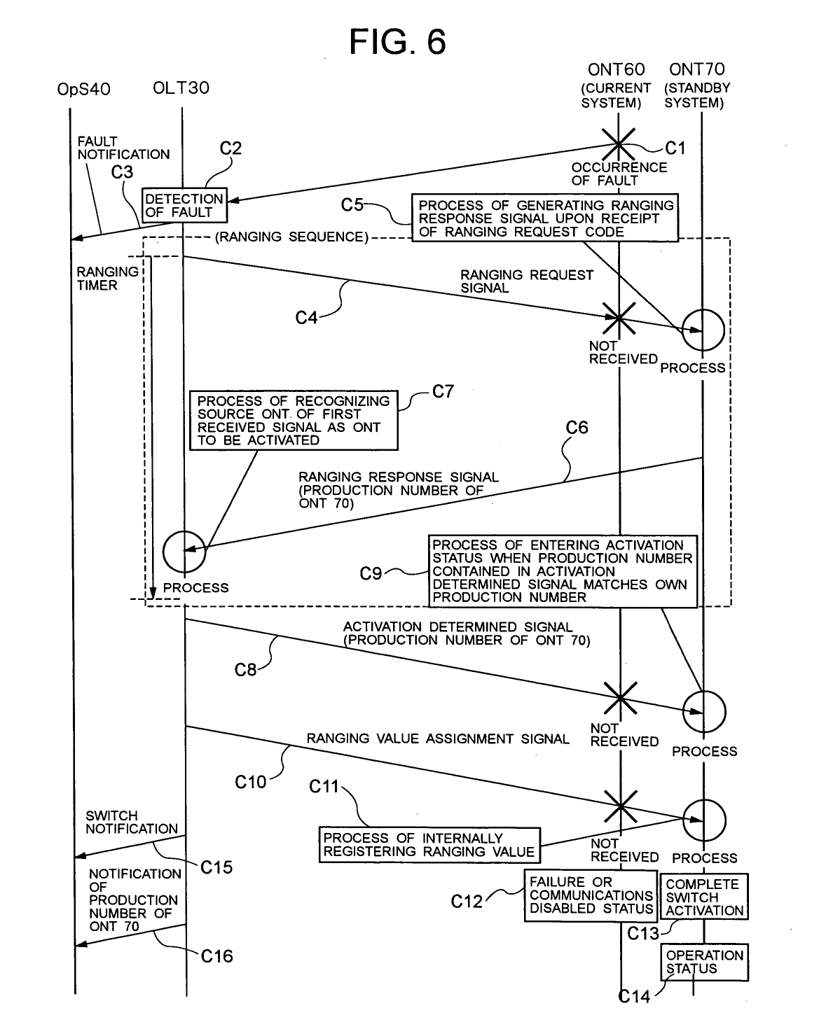

FIG. 6 shows a sequence of a switching operation of the data communications system according to the embodiment of the present invention when a fault occurs. Switching operation in failure occurrence will be described with reference to FIGS. 1, 2 and 6.

If a fault (a failure of the current ONT 60 or power-down, or a failure of the optical fiber between the coupler 50 and the current ONT 60) occurs in the operation of the ONT 60 as a current ONT (step Cl shown in FIG. 6), then the OLT 30 detects it and notifies the OpS 40 of the occurrence of the fault (steps C2 and C3 in FIG. 6).

The OLT 30 performs the ranging sequence. First, the OLT 30 transmits to the ONTs 60 and 70 a ranging request signal including the transmit request code assigned to the ONTs 60 and 70 (step C4 shown in FIG. 6). The OLT 30 also starts the ranging timer, and monitors the presence/absence of a response from the ONTs 60 and 70.

The current ONT 60 cannot issue a response because the fault has occurred, and only the standby ONT 70 receives the ranging request signal, generates a ranging response signal including a source ONT-ID “n” and the production number of the ONT 70, and transmits the signal to the OLT 30 (steps C5 and C6 shown in FIG. 6).

The OLT 30 recognizes as a system to be activated the source ONT (standby ONT 70) of the first received ranging response signal within a predetermined time after the ranging request signal is transmitted (step C7 shown in FIG. 6), and transmits a activation determined signal including a destination ONT-ID “n” and the production number of the ONT 70 to switch from the current ONT 60 to the standby ONT 70 (step C8 shown in FIG. 6).

The ONT 70 is activated when the activation determined signal including the production number matching that of the ONT 70 is received (step C9 shown in FIG. 6), and the ONT 60 does not receive a signal because the fault has occurred.

To appropriately delay an up signal of the ONT 70 so that the up signal from the ONT 70 cannot conflict with the up signal from the ONT 80, the OLT 30 transmits a ranging value assignment signal including the delay value and a destination ONT-ID “n” (step C10 shown in FIG. 6).

When the ONT 70 receives the ranging value assignment signal from the OLT 30, the delay value contained in the ranging value assignment signal is set in the delay insertion unit 16 of the ONT 70 (step C11 shown in FIG. 6). On the other hand, the ONT 60 does not receive a signal because the fault has occurred.

Thus, the ONT 70 is activated and enters an operation status (steps C13 and C14 shown in FIG. 6). On the other hand, the ONT 60 is in a failure or communication disabled status (step C12 shown in FIG. 6).

The OLT 30 notifies the OpS 40 of the switch of the ONTs, and notifies it of the production number of the ONT 70 (steps C15 and C16 shown in FIG. 6).

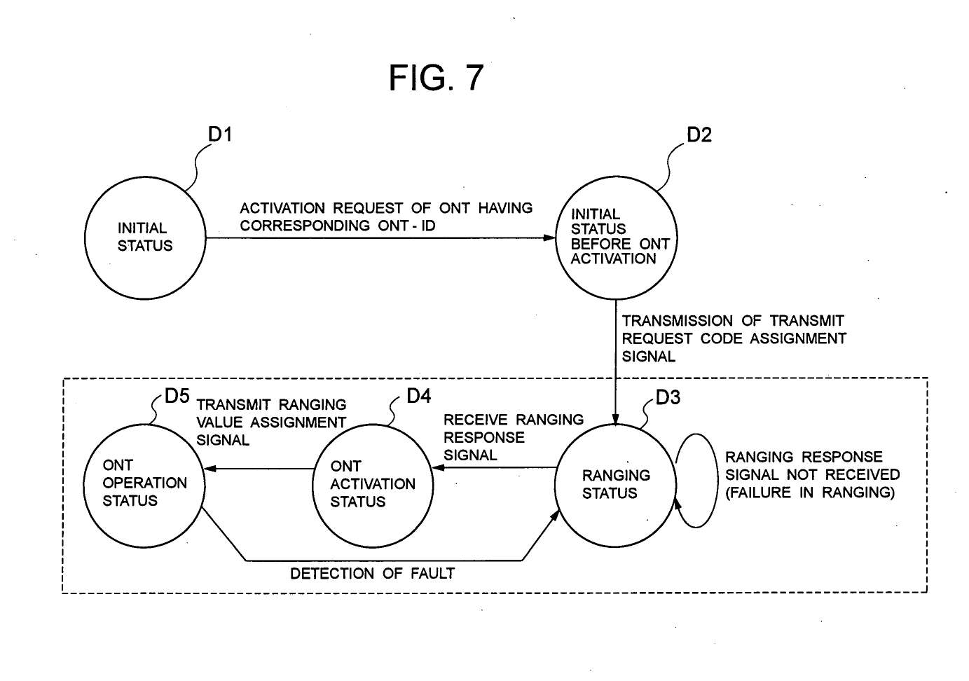

FIG. 7 is a state transition diagram showing the above-mentioned operations of the OLT 30. As shown in FIG. 7, when the OLT 30 in a initial status D1 receives from the OpS 40 a ONT activation request on the same ONT-ID held by the ONTs 60 and 70, it enters an initial status D2 before ONT activation.

When the OLT 30 enters the initial status D2 before ONT activation, it transmits a transmit request code assignment signal to the ONTs 60 and 70, and enters a ranging status D3. When the OLT 30 enters the ranging status D3, it transmits a ranging request signal to the ONTs 60 and 70. If the OLT 30 can receive a ranging response signal, then the OLT 30 enters an ONT activation status D4.

Then, the OLT 30 transmits a ranging value assignment signal, and enters an ONT operation status D5. If the OLT 30 detects a fault between the current ONT and the coupler 50, that is, if it detects a fault due to a failure of the current ONT or power-down, or a failure of the optical fiber between the coupler 50 and the current ONT 60, then the OLT 30 returns to the ranging status D3.

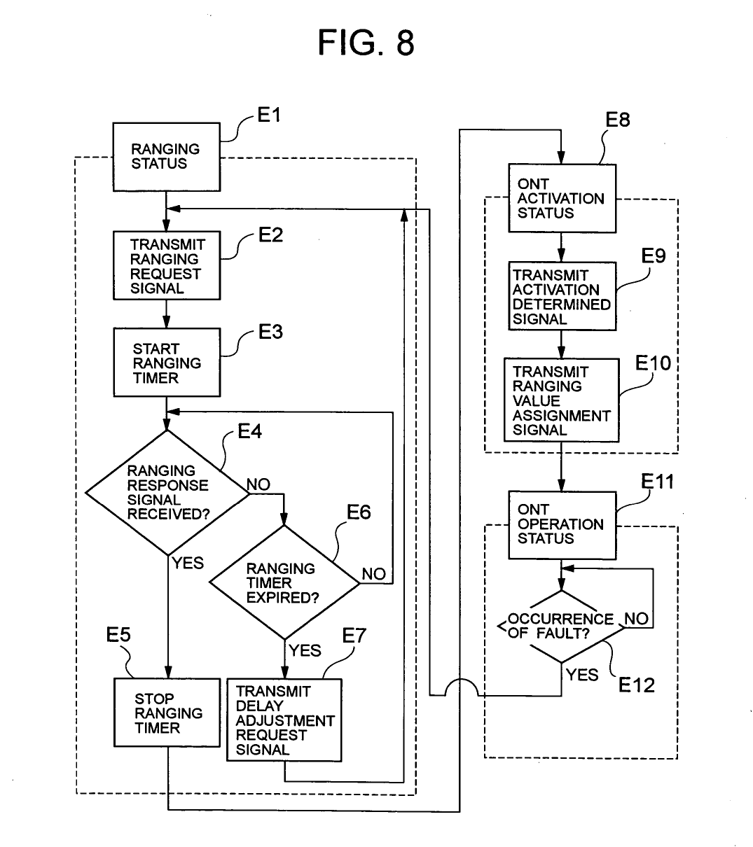

FIG. 8 is a flowchart of the operations of the OLT 30. As shown in FIG. 8, when the OLT 30 enters the ranging status D3 (step El shown in FIG. 8), it transmits a ranging request signal to the ONTs 60 and 70 (step E2 shown in FIG. 8), and starts the ranging timer (step E3 shown in FIG. 8).

When the OLT 30 receives a ranging response signal within a predetermined time after the ranging request signal is transmitted (step E4 shown in FIG. 8), the OLT 30 stops the ranging timer (step E5 shown in FIG. 8), and enters the ONT activation status D4 (step E8 shown in FIG. 8).

On the other hand, if the OLT 30 cannot receive a ranging response signal within the predetermined time after the ranging request signal is transmitted (steps E4 and E6 shown in FIG. 8), then the OLT 30 transmits a delay adjustment request signal (step E7 shown in FIG. 8), thereby returning control to step E2.

When the OLT 30 enters the ONT activation status D4 (step E8 shown in FIG. 8), it transmits an activation determined signal (step E9 shown in FIG. 8), and transmits a ranging value assignment signal (step E10 shown in FIG. 8). Then, the OLT 30 enters the ONT operation status D5 (step Ell shown in FIG. 8).

If the OLT 30 detects a fault between the current ONT and the coupler 50 in the ONT operation status D5 (step E12 shown in FIG. 8), the OLT 30 enters the ranging status D3, and transmits again the ranging request signal (step E2 shown in FIG. 8).

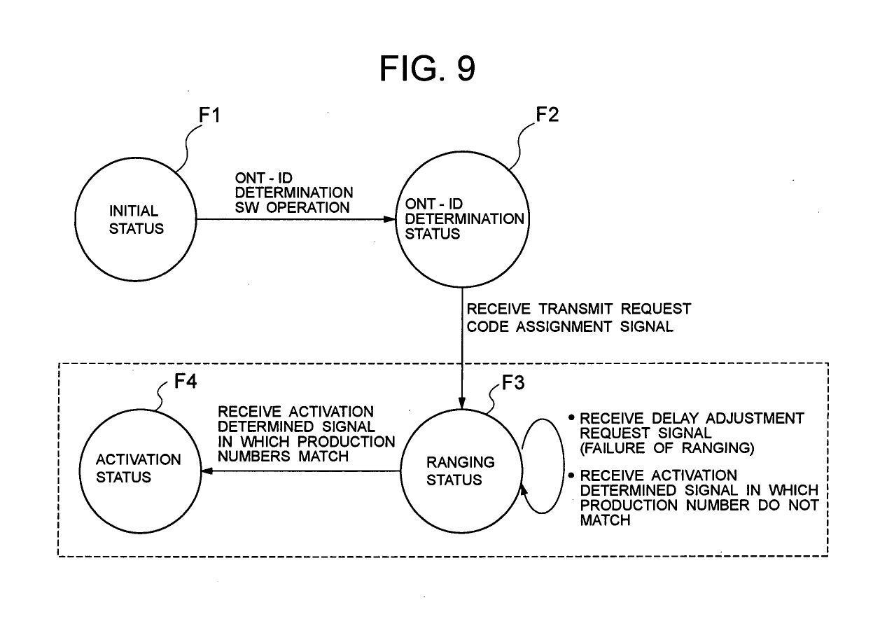

FIG. 9 is a state transition diagram showing the above-mentioned operations of each of the ONTs 60 and 70. As shown in FIG. 9, when an ONT-ID is written to the nonvolatile memory 21 by the operation of the ONT-ID determination switch 22 in an initial status F1, the ONT (each of the OTNs 60 and 70) enters an ONT-ID determination status F2.

When the ONT receives a transmit request code assignment signal from the OLT 30, it enters a ranging status F3. In the ranging status F3, when the ONT receives an activation determined signal including a production number matching the production number of the ONT, it enters an activation status (operation status) F4. On the other hand, if the ONT receives a delay adjustment request signal, or if it receives an activation determined signal including a production number different from the production number of the ONT, then the ONT maintains the ranging status F3.

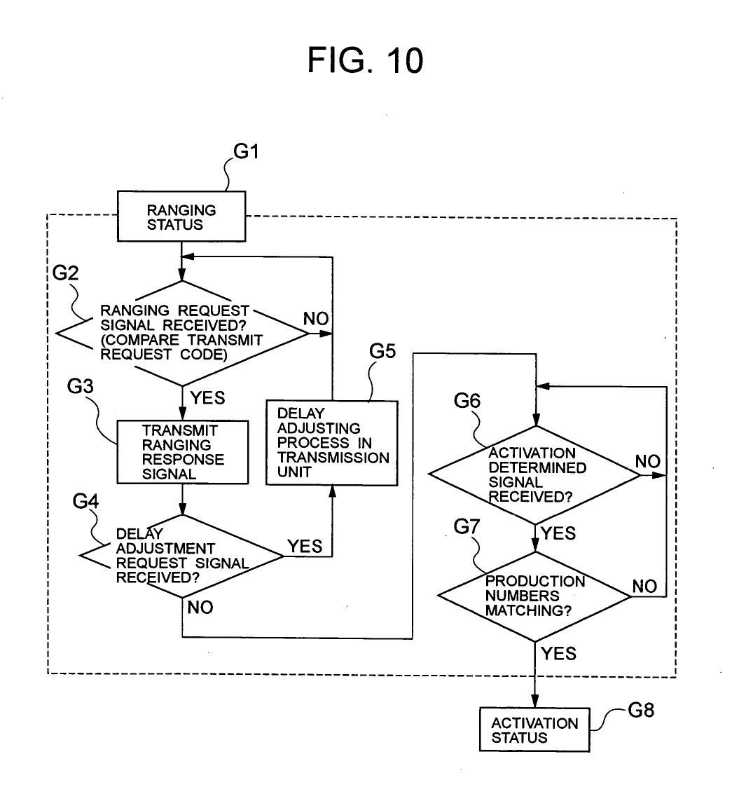

FIG. 10 is a flowchart of the operations of each of the ONTs 60 and 70. As shown in FIG. 10, when the ONT (each of the ONTs 60 and 70) in the ranging status F3 receives a ranging request signal including a transmit request code assigned to the ONT (step G1 and G2 shown in FIG. 10), it transmits a ranging response signal (step G3 shown in FIG. 10).

When the ONT receives a delay adjustment request signal (step G4 shown in FIG. 10), it determines a delay value at random to delay an up signal, and sets the value in the delay insertion unit 16 (step G5 shown in FIG. 10).

On the other hand, if the ONT receives an activation determined signal without receiving a delay adjustment request signal (steps G4 and G6 shown in FIG. 10), then the ONT compares the production number contained in the activation determined signal with the production number of the ONT (step G7 shown in FIG. 10), and enters the activation status F4 when they match (step G8 shown in FIG. 10).

As explained above, according to the embodiment of the present invention, the OLT 30 performs the ranging on the ONTs 60 and 70 forming a redundant system, and determines the ONT for communicating with the OLT 30. Therefore, the OLT 30 can switch from the current ONT to the standby ONT without a switch instruction from the OpS 40.

In the embodiment of the present invention, two ONTs 60 and 70 are set with the same ONT-ID to realize a duplex system between the coupler and the ONT, but the present invention is not limited to this configuration, but three or more ONTs can be set with the same ONT-ID, thereby possibly realizing a PON with a multiple redundant configuration such as a triplex, quadplex, . . .

The processing operations of each of the OLT and the ONT according to each flowchart shown in FIGS. 8 and 10 can also be realized by allowing a computer, that is, the CPU (control unit), to read a program stored in a storage medium such as ROM or the like.

1. A data communications system in which a plurality of subscriber devices forming a redundant configuration are connected to a station device through an optical multi/demultiplexer, wherein
said station device comprises control means determining from among the plurality of subscriber devices a subscriber device for communicating with the station device by performing ranging on the plurality of subscriber devices.

2. The data communications system according to claim 1, wherein:
said control means comprises transmission means transmitting a ranging request signal to the plurality of subscriber devices; each of the plurality of subscriber devices comprises transmission means transmitting a ranging response signal in response to reception of the ranging request signal; said control means determines a subscriber device for communicating with the station device based on the ranging response signal from the plurality of subscriber devices.

3. The data communications system according to claim 2, wherein
said control means determines a source subscriber device of a first received ranging response signal as a subscriber device for communicating with the station device.

4. The data communications system according to claim 2, wherein
said transmission means of the station device transmits again the ranging request signal when the ranging response signal is not received within a predetermined time after transmission of the ranging request signal.

5. The data communications system according to claim 4, wherein
said transmission means of the station device transmits a delay adjustment request signal to the plurality of subscriber devices before transmitting the ranging request signal again, each of the plurality of subscriber devices sets at random a delay value in said transmission means of the subscriber device in response to reception of the delay adjustment request signal.

6. The data communications system according to claim 1, wherein
said ranging is performed in response to detection of a fault between a current subscriber device in the plurality of subscriber devices and the optical multi/demultiplexer.

7. A redundant configuration switch determination method for use with a data communications system in which a plurality of subscriber devices forming a redundant configuration are connected to a station device through an optical multi/demultiplexer, wherein
said station device determines from among the plurality of subscriber devices a subscriber device for communicating with the station device by performing ranging on the plurality of subscriber devices.

8. The redundant configuration switch determination method according to claim 7, comprising:
a first step of, in the station device, transmitting aranging request signal to the plurality of subscriber devices; a second step of, in each of the plurality of subscriber devices, transmitting a ranging response signal in response to reception of the ranging request signal; and a third step of, in the station device, determining a subscriber device for communicating with the station device based on the ranging response signal from the plurality of subscriber devices.

9. The redundant configuration switch determination method according to claim 8, wherein
said third step determines a source subscriber device of a first received ranging response signal as a subscriber device for communicating with the station device.

10. The redundant configuration switch determination method according to claim 8, comprising a step of,
in the station device, transmitting again the ranging request signal when the ranging response signal is not received within a predetermined time after transmission of the ranging request signal.

11. The redundant configuration switch determination method according to claim 10, comprising:
a step of, in the station device, transmitting a delay adjustment request signal to the plurality of subscriber devices before transmitting again the ranging request signal; a step of, in each of the plurality of subscriber devices, setting a delay value at random for transmission in the second step of transmitting a ranging response signal in response to reception of the delay adjustment request signal.

12. The redundant configuration switch determination method according to claim 7, wherein
said ranging is performed in response to detection of a fault between a current subscriber device in the plurality of subscriber devices and the optical multi/demultiplexer.

13. A station device in a data communications system in which a plurality of subscriber devices forming a redundant configuration are connected to a station device through an optical multi/demultiplexer, comprising
control means determining from among the plurality of subscriber devices a subscriber device for communicating with the station device by performing ranging on the plurality of subscriber devices.

14. The station device according to claim 13, wherein
said control means comprises transmission means transmitting to the plurality of subscriber devices a ranging request signal for a prompt to transmit a ranging response signal, and determines a subscriber device for communicating with the station device based on the ranging response signal from the plurality of subscriber devices.

15. The station device according to claim 14, wherein
said control means determines a source subscriber device of a first received ranging response signal as a subscriber device for communicating with the station device.

16. The station device according to claim 14, wherein
said transmission means transmits again the ranging request signal when the ranging response signal is not received within a predetermined time after transmission of the ranging request signal.

17. The station device according to claim 16, wherein
said transmission means transmits a delay adjustment request signal to the plurality of subscriber devices so that each of the plurality of subscriber devices assigns a delay value at random in transmitting the ranging response signal before transmitting again the ranging request signal.

18. The station device according to claim 13, wherein
said ranging is performed in response to detection of a fault between a current subscriber device in the plurality of subscriber devices and the optical multi/demultiplexer.

19. A redundant configuration switch determination method of a station device in a data communications system in which a plurality of subscriber devices forming a redundant configuration are connected to a station device through an optical multi/demultiplexer, wherein
from among the plurality of subscriber devices, a subscriber device for communicating with the station device is determined by performing ranging on the plurality of subscriber devices.

20. The redundant configuration switch determination method according to claim 19, comprising:
a first step of transmitting to the plurality of subscriber devices a ranging request signal as a prompt to transmit a ranging response signal; and a second step of determining a subscriber device for communicating with the station device based on the ranging response signal from the plurality of subscriber devices.

21. The redundant configuration switch determination method according to claim 20, wherein
said second step determines a source subscriber device of a first received ranging response signal as a subscriber device for communicating with the station device.

22. The redundant configuration switch determination method according to claim 20, comprising
a step of transmitting again the ranging request signal when the ranging response signal is not received within a predetermined time after transmission of the ranging request signal.

23. The redundant configuration switch determination method according to claim 22, comprising
a step of transmitting a delay adjustment request signal to the plurality of subscriber devices so that each of the plurality of subscriber devices assigns a delay value at random in transmitting the ranging response signal before transmitting again the ranging request signal.

24. The redundant configuration switch determination method according to claim 19, wherein
said ranging is performed in response to detection of a fault between a current subscriber device in the plurality of subscriber devices and the optical multi/demultiplexer.

25. A subscriber device in a data communications system which includes a station device, an optical multi/demultiplexer, and a plurality of subscriber devices forming a redundant configuration connected to the station device through the optical multi/demultiplexer, and in which the station device determines from among the plurality of subscriber devices a subscriber device for communicating with the station device by performing ranging on the plurality of subscriber devices, comprising
transmission means transmitting to the station device a ranging response signal for use in determining a subscriber device for communicating with the station device upon receipt of a ranging request signal transmitted from the station device to the plurality of subscriber devices.

26. The subscriber device according to claim 25, wherein
a delay value is set in said transmission means at random in response to reception of a delay adjustment request signal transmitted from the station device to the plurality of subscriber devices.

27. An operation control method of a subscriber device in a data communications system which includes a station device, an optical multi/demultiplexer, and a plurality of subscriber devices forming a redundant configuration connected to the station device through the optical multi/demultiplexer, and in which the station device determines from among the plurality of subscriber devices a subscriber device for communicating with the station device by performing ranging on the plurality of subscriber devices, comprising
a step of transmitting to the station device a ranging response signal for use in determining a subscriber device for communicating with the station device upon receipt of a ranging request signal transmitted from the station device to the plurality of subscriber devices.

28. The operation control method according to claim 27, comprising
a step of setting a delay value at random for transmission in the transmitting step in response to reception of a delay adjustment request signal transmitted from the station device to the plurality of subscriber devices.

29. A program used to direct a computer to execute a redundant configuration switch determination method of a station device in a data communications system in which a plurality of subscriber devices forming a redundant configuration are connected to a station device through an optical multi/demultiplexer, comprising
a step of determining from among the plurality of subscriber devices a subscriber device for communicating with the station device by performing ranging on the plurality of subscriber devices.

30. A program used to direct a computer to execute an operation control method of a subscriber device in a data communications system which includes a station device, an optical multi/demultiplexer, and a plurality of subscriber devices forming a redundant configuration connected to the station device through the opticalmulti/demultiplexer, and in which the station device determines from among the plurality of subscriber devices a subscriber device for communicating with the station device by performing ranging on the plurality of subscriber devices, comprising
a step of transmitting to the station device a ranging response signal for use in determining a subscriber device for communicating with the station device upon receipt of a ranging request signal transmitted from the station device to the plurality of subscriber devices.
